(19) United States
(12) Patent Application Publication
(10) Pub. No.: US 2019/0309797 A1
(43) Pub. Date: Oct. 10, 2019

(54) SPLINE JOINT

(71) Applicant: ROLLS-ROYCE plc, London (GB)

(72) Inventor: Davide NICOLETTI, Derby (GB)

(73) Assignee: ROLLS-ROYCE plc, London (GB)

(21) Appl. No.: 16/295,527

(22) Filed: Mar. 7, 2019

(30) Foreign Application Priority Data
Apr. 4, 2018 (GB) 1805521.0

(51) Int. Cl. F16D 1/10; F16H 57/04

(52) U.S. Cl. CPC F16D 1/10; F05D 2220/32; F16D 2001/103; F16H 57/0431

(57) ABSTRACT

A spline joint comprising: a sidewall extending along and around an axis defining an axial direction of the joint, wherein the sidewall defines a passage extending from a first end to a second end; wherein the passage is arranged to receive an end of a shaft at the first end; and wherein an engagement portion of an inner surface of the sidewall adjacent the first end is arranged to engage a shaft received in the passage, to transmit torque to the shaft; a base wall extending across the passage and axially spaced from the first end of the passage; an opening formed through the base wall; and an inner wall extending around the opening and in the axial direction from the base wall, such that an annular trough arranged to retain lubricant for the spline joint is defined between the sidewall and the inner wall.

The present disclosure relates to a spline joint. In particular, but not exclusively, the present disclosure relates to a spline joint for use in an accessory drive train of a gas turbine engine, or any other radially extending drive train of a gas turbine engine.

A gas turbine engine typically includes a core engine, having one or more compressor stages feeding air to a combustor. The compressor stages are driven by corresponding turbine stages downstream of the combustor. The compressor stages are linked to the turbine stages by one or more core shafts, extending along a principle axis of the engine.

The engine includes an accessory unit that provides power to hydraulic, pneumatic and electrical systems of the engine. The accessory unit is typically located outside the core engine, radially spaced from the principle axis. The accessory unit is also driven by the core engine. Torque is transferred from the core engine to the accessory unit by an accessory drive train extending out from one of the core shafts. In order to deliver torque to the accessory unit, the accessory drive train may need to use one or more spline joints to couple shafts together, or to couple shafts to the accessory unit, an accessory gearbox (such as a step aside gearbox) and the like.

A spline joint is formed by projections or ridges formed in a first piece, which engage with corresponding grooves formed in a second piece, to transfer torque. For example, a first shaft may have axially extending ridges formed on an inner surface, which engage with corresponding grooves formed on the outer surface of a second shaft. The second shaft is then located inside the first, to couple the two together.

In some cases, the splined joint may be an articulated spline. An articulated spline is a joint which can accommodate some relative movement (usually tilting of the shaft away from the axial direction) between the parts joined together.

As a result of the relative movement, articulated splines require lubrication. In gas turbine engines, it is known to provide lubricant through a lubrication system powered by the accessory drive. However, as the lubrication system is powered by the accessory drive, lubricant is not provided when the engine is starting, stopping, or at low rotational speed (engine transients).

Coatings, such as silver plating, may be used at the spline, to reduce friction. However, these can be worn away with use. Alternatively, a wall may be provided within a shaft, close to an articulating spline joint. This forms a trough for collecting oil. However, where a pressure difference is formed across the joint, the closed wall may result in relative axial movement of the shaft to release pressure.

It is therefore desired to provide an alternative way to lubricate an articulated spline.

According to a first aspect there is provided a spline joint comprising: a sidewall extending along and around an axis defining an axial direction of the joint, wherein the sidewall defines a passage extending from a first end to a second end; wherein the passage is arranged to receive an end of a shaft at the first end; and wherein an engagement portion of an inner surface of the sidewall adjacent the first end is arranged to engage a shaft received in the passage, to transmit torque to the shaft; a base wall extending across the passage and axially spaced from the first end of the passage; an opening formed through the base wall; and an inner wall extending around the opening and in the axial direction from the base wall, such that an annular trough arranged to retain lubricant for the spline joint is defined between the sidewall and the inner wall.

The spline joint ensures that a controlled amount lubricant can be collected in the joint, and used to lubricate the joint. The amount of oil can be controlled to minimise unbalanced loads on the shaft. The opening also allows for airflow through the joint, to prevent joint sliding environments with a pressure differential formed along a drive train.

The spline joint may be axisymmetric.

The inner wall may extend from a first end, to a second end. The first end of the inner wall may be between the first end of the passage and the base wall, and the second end of the inner wall may be at the base wall.

The engagement portion may extend a portion of the axial length of the sidewall from the first end. The first end of the inner wall may be axially spaced from the engagement portion.

The trough may be arranged to provide lubricant to the engagement portion through centrifugal force.

The axial direction may be at least 45 degrees to horizontal. The axial direction may be perpendicular to horizontal.

The spline joint may be an articulating spline.

The spline joint may include: a second engagement portion arranged to engage another shaft extending in the axial direction. The second engagement portion may be radially outside the engagement portion on the inner surface of the passage. The second engagement portion may be arranged to be received within the other shaft, such that the spline joint comprises an adapter arranged to join a first shaft received in the passage and a second shaft receiving the spline joint. The base wall may close the second end of the passage. The second engagement portion may be arranged to form a rigid joint to the second shaft.

Alternatively, the spline joint may be formed in an end of a shaft, such that the spline joint joins a shaft incorporating the passage and a shaft received in the passage.

According to a second aspect, there is provided a gas turbine engine for an aircraft comprising: an engine core including a turbine, a compressor, and a core shaft driven by the turbine; an accessory unit for driving hydraulic, pneumatic and electrical systems of the turbine engine; a fan located upstream of the engine core, the fan comprising a plurality of fan blades and being driven by the engine core; and an accessory drive train for providing a portion of the power of the core shaft to the accessory unit, wherein the accessory drive train extends radially from the core shaft; and wherein the accessory drive train includes a spline joint according to the first aspect.

The spline joint ensures that a controlled amount lubricant can be collected in the joint at engine shutdown, or during transients, and used to lubricate the joint at start up or during engine transients, when the joint is not supplied with lubricant. The amount of oil can be controlled to minimise unbalanced loads on the shaft. The opening also allows for airflow through the joint, to prevent joint sliding in high pressure environments.

The gas turbine engine may include a lubrication system arranged to deliver lubricant to the spline joint, during engine operation. The lubrication system may be driven by the accessory unit. The trough of the spline joint may deliver lubricant, when the lubrication system of the engine is not primed, or provided with sufficient power.

A radial width of the trough between the sidewall and inner wall, and an axial length of the inner wall may be arranged such that the volume of lubricant in the trough on engine shutdown is equal or substantially equal to the volume of lubricant provided during engine operation. Excess lubricant may flow through the opening.

The core shaft may have a principal axis. The accessory drive train may include a first shaft, operatively coupled to the spline joint. The first shaft may extend at an angle of 45 degrees or more from the principal axis of the core shaft.

The gas turbine engine may include a power gearbox that receives an input from the core and outputs drive to the fan. The power gearbox may be a step down gearbox.

The gas turbine engine as described and/or claimed herein may have any suitable general architecture. For example, the turbine may be a first turbine, the compressor may be a first compressor, and the core shaft may be a first core shaft. The engine may further comprise a second turbine, a second compressor, and a second core shaft connecting the second turbine to the second compressor.

The second core shaft may be arranged to rotate at a lower rotational speed than the first core shaft. The input to the power gearbox may be provided by the first core shaft or the second core shaft. In such an arrangement, the first compressor may be positioned axially downstream of the second compressor. The first compressor may be arranged to receive (for example directly receive, for example via a generally annular duct) flow from the second compressor. Similarly, the second turbine may be positioned axially downstream of the first turbine. The first turbine may be arranged to receive (for example directly receive, for example via a generally annular duct) flow from the first turbine.

The power gearbox may be arranged to be driven by the core shaft that is configured to rotate (for example in use) at the lowest rotational speed (for example the second core shaft in the example above). For example, the gearbox may be arranged to be driven only by the core shaft that is configured to rotate (for example in use) at the lowest rotational speed (for example only be the second core shaft, and not the first core shaft, in the example above). Alternatively, the gearbox may be arranged to be driven by any one or more shafts, for example the first and/or second shafts in the example above.

The accessory drive may be driven by the by the core shaft that is configured to rotate (for example in use) at the fastest rotational speed (for example the first core shaft in the example above). Alternatively, the accessory drive may be arranged to be driven by any one or more shafts in the engine, for example the first and/or second shafts in the example above.

In any gas turbine engine as described and/or claimed herein, a combustor may be provided axially downstream of the fan and compressor(s). The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 (around 150 inches) cm or 390 cm (around 155 inches). The fan diameter may be in an inclusive range bounded by any two of the values in the previous sentence (i.e. the values may form upper or lower bounds).

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity Uₜᵢₚ. The work done by the fan blades on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as fan tip radius at leading edge multiplied by angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (all units in this paragraph being Jkg⁻¹K⁻¹/(ms⁻¹)²). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15 deg C. (ambient pressure 101.3 kPa, temperature 30 deg C.), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge. A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent. Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9. Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges. Purely by way of example, the cruise conditions may correspond to: a forward Mach number of 0.8; a pressure of 23000 Pa; and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust. The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Embodiments will now be described by way of example only, with reference to the Figures, in which:

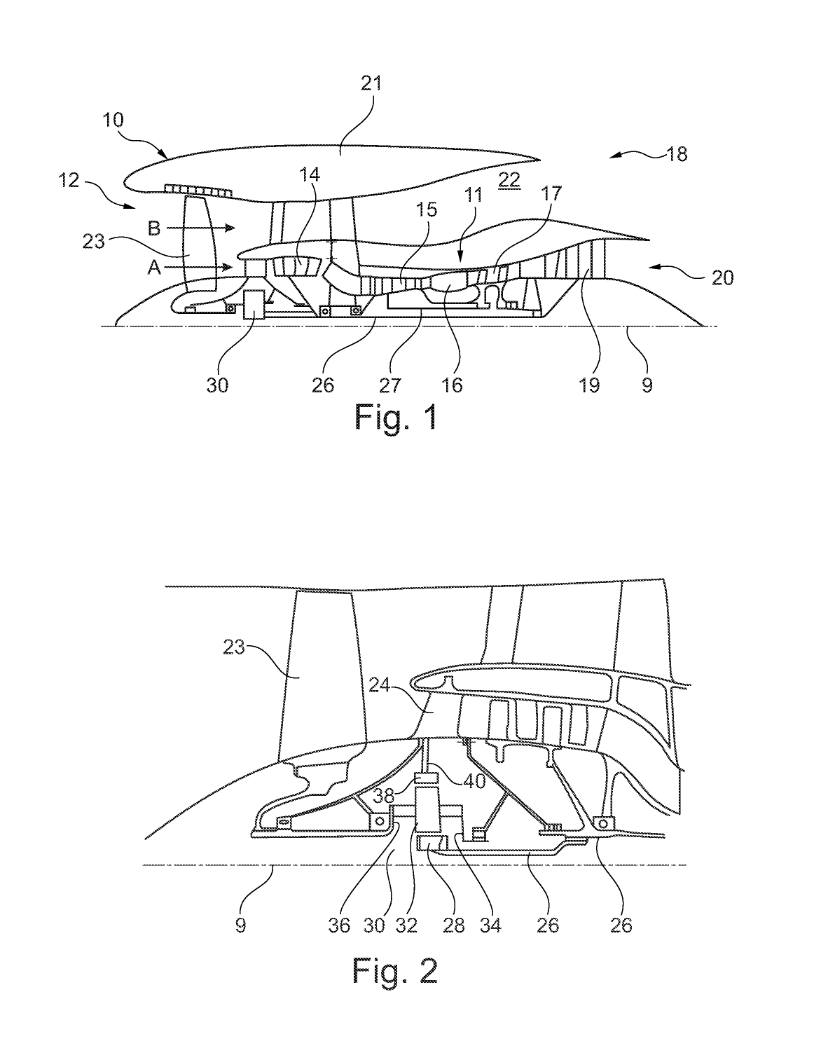

FIG. 1 is a sectional side view of a gas turbine engine;

FIG. 2 is a close up sectional side view of an upstream portion of a gas turbine engine;

FIG. 3 is a partially cut-away view of a power gearbox for a gas turbine engine;

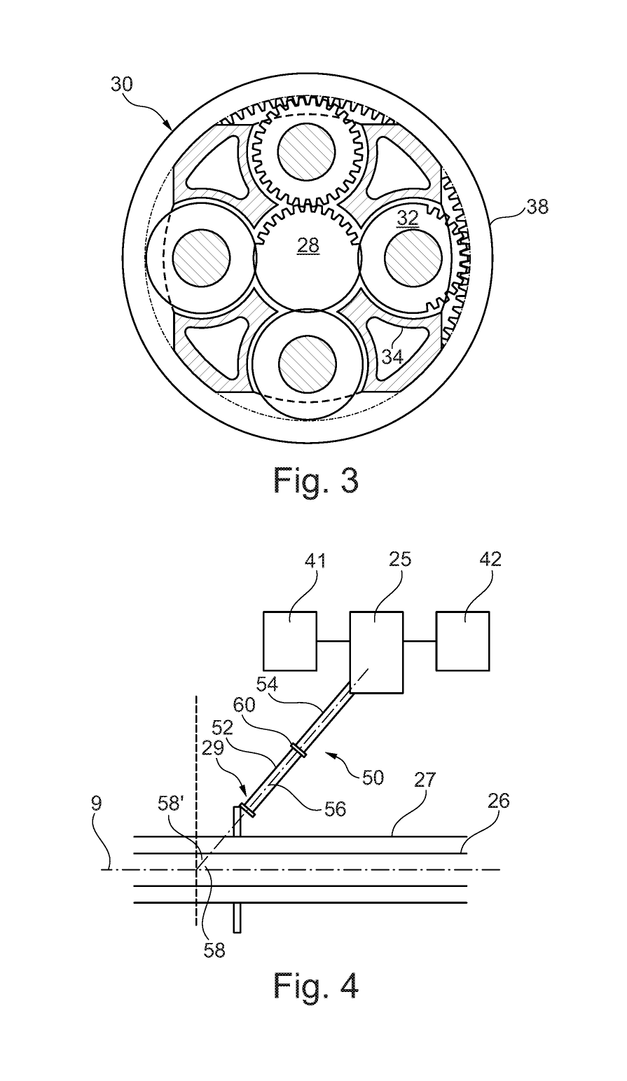

FIG. 4 is a schematic sectional side view of an accessory unit and accessory drive train of a gas turbine engine;

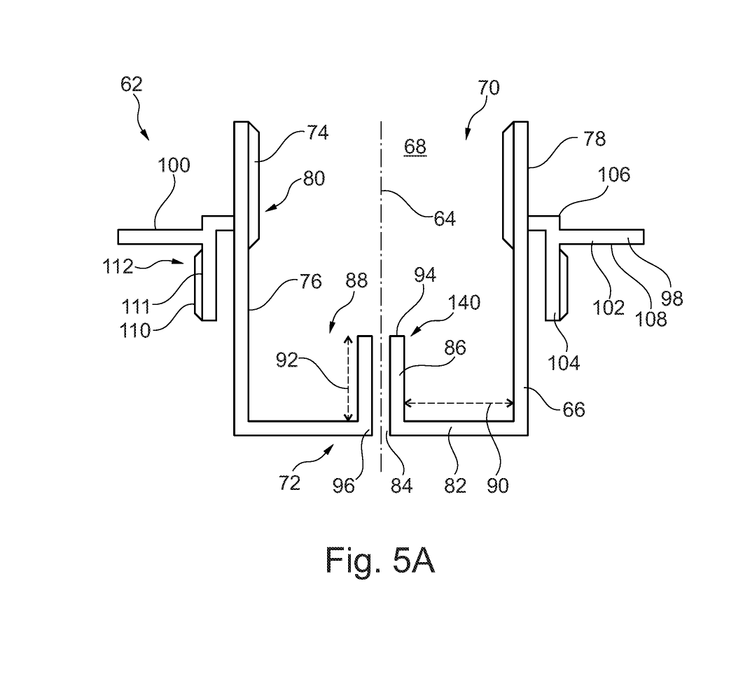

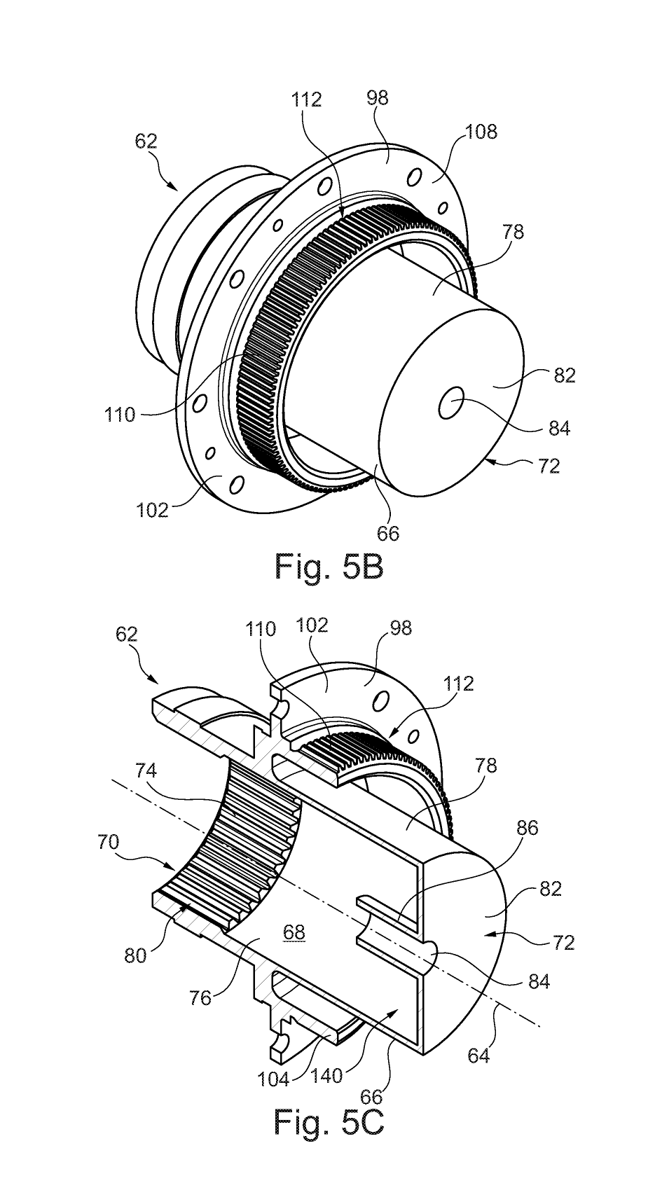

FIG. 5A schematic sectional side view of a spline joint adapter for use in the drive train of FIG. 4;

FIG. 5B perspective view of a spline joint adapter of FIG. 5A;

FIG. 5C sectional perspective view of a spline joint adapter of FIG. 5A;

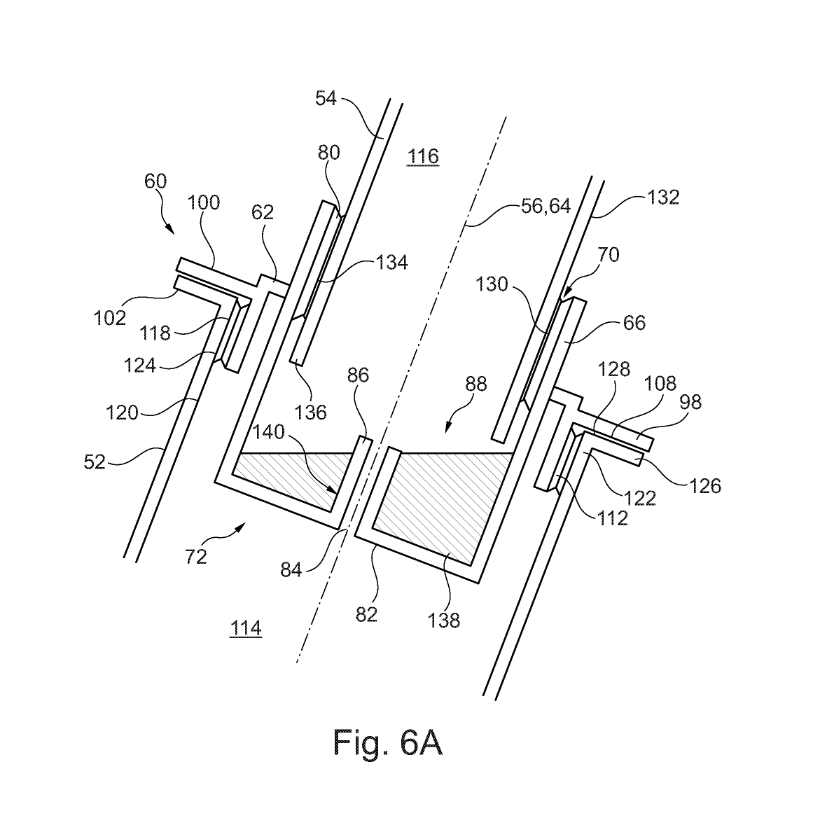

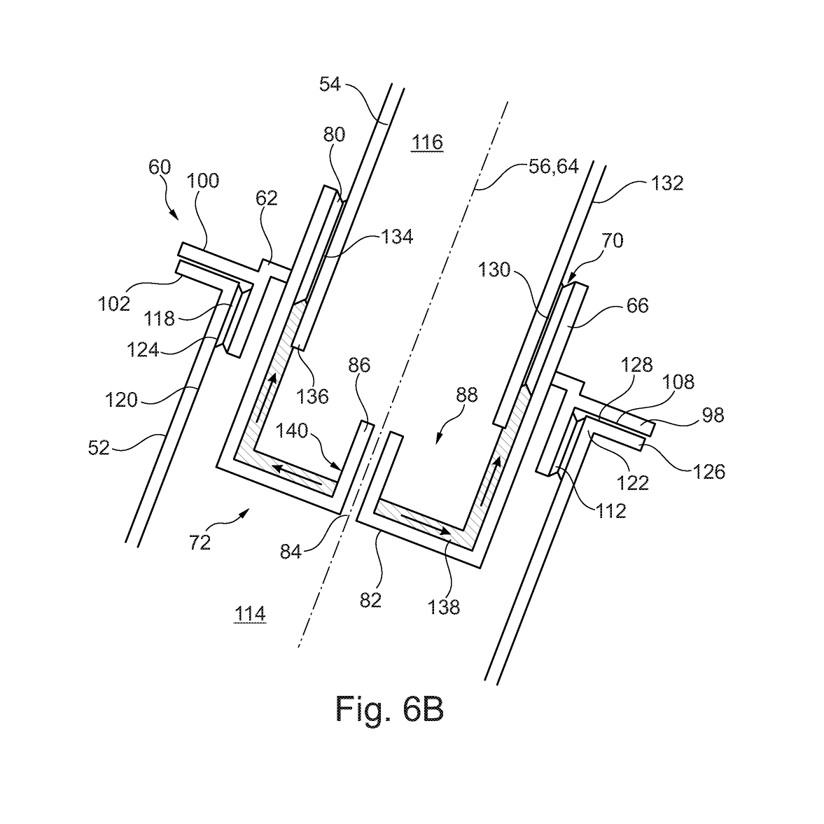

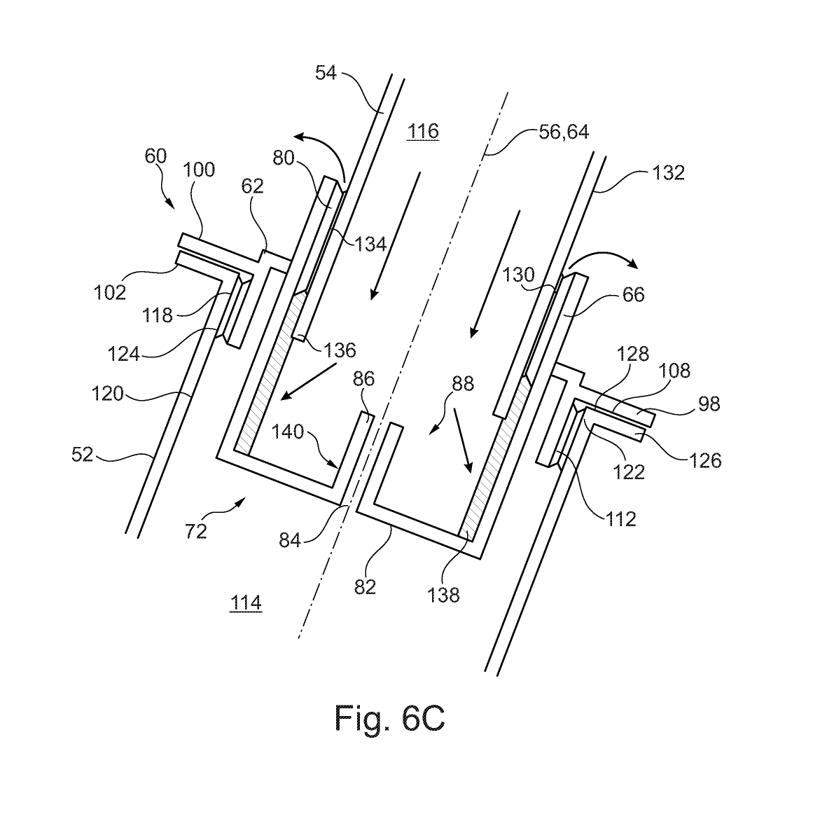

FIG. 6A is a perspective section view of a spline joint between two shafts, using the adapter of FIG. 5A, at engine shut-down;

FIG. 6B is a perspective section view of a spline joint between two shafts, using the adapter of FIG. 5A, at engine start-up;

FIG. 6C is a perspective section view of a spline joint between two shafts, using the adapter of FIG. 5A, during engine operation;

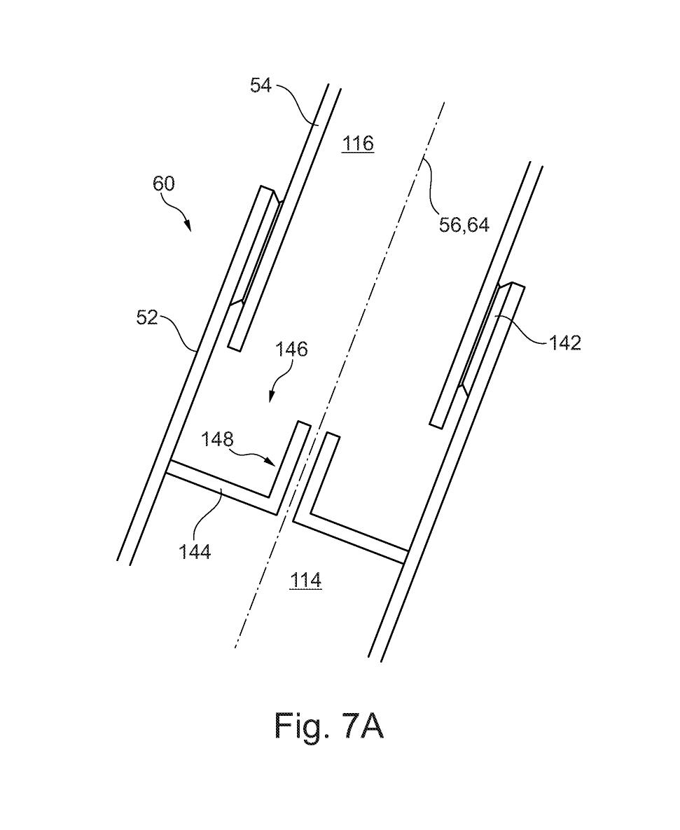

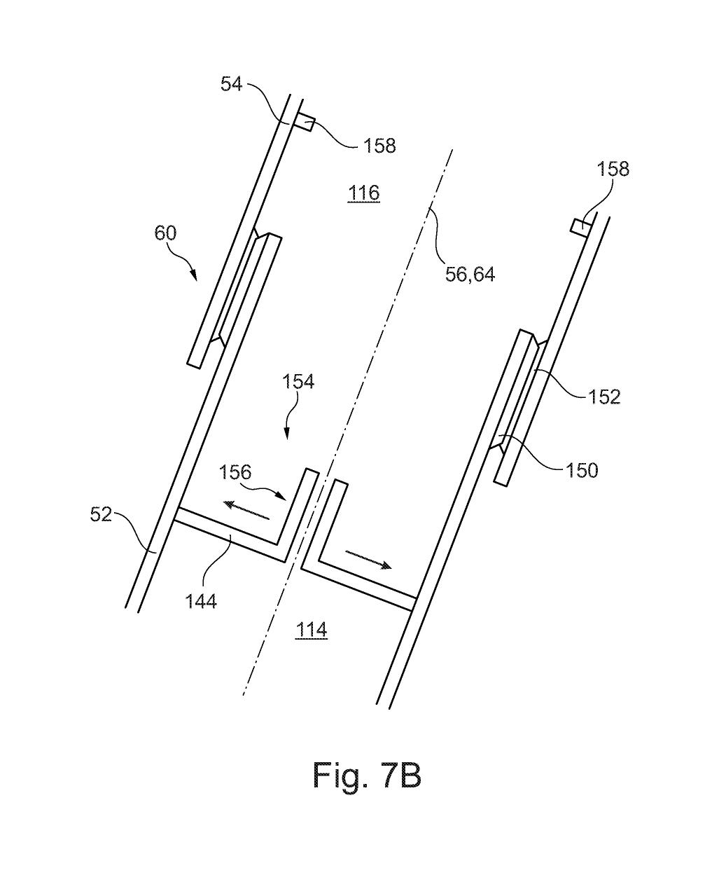

FIG. 7A is a perspective section view of a first alternative spline joint between two shafts; and

FIG. 7B is a perspective section view of a second alternative spline joint between two shafts.

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to process around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

Gas turbine engines 10 such as the one discussed above include an accessory unit 25 that can provide power to the hydraulic, pneumatic and electrical systems 41 of an aircraft on which the engine 10 is mounted. The accessory unit 25 can also power ancillary systems of the gas turbine engine 10, such as a lubrication system 42.

The accessory unit 25 is located radially outside the core engine 11. The drive for the accessory unit 25 is taken from the core shaft 27 interconnecting the high pressure turbine 17 and the high pressure compressor 15. The drive is provided by a drive train 50 extending from the core shaft 27 to the accessory unit. In the example shown, the drive train 50 is formed of a first shaft 52, and a second shaft 54.

The radial drive train 50 is coupled to the core shaft 27 at an internal gearbox 29, which transmits torque from the core shaft 27 to the first shaft 52. The torque is transmitted to the second shaft 54 through a spline joint 60, and into an external gearbox (not shown) within the accessory unit. The external gearbox provides a mount for the various accessory systems, and transmits appropriate geared drive to each system.

The drive train 50 has an axis 56 extending down the centre of the first radial shaft 52. As shown in FIG. 4, the drive train 50 extends in an axial direction, as well as a radial direction. Therefore, the drive train axis 56 is inclined with respect to the principle axis 9 of the engine 10. The incline may be defined by a first angle 58 between the principle axis 9 and the drive train axis 56 or a second angle 58′ between the radial direction (radial to the principal axis 9) and the drive train axis 56. The sum of the first and second angle 58, 58′ is always 90 degrees.

The principal axis 9, and drive train axis 56 are parallel when the first angle 58 is 0 degrees and the second angle is 90 degrees (i.e. the drive train axis 56 extends fully axially), and the axes 9, 56 are perpendicular when the first angle 58 is 90 degrees and the second angle 58′ is 0 (i.e. the drive train axis 56 extends fully radially). The principle axis 9 of the engine defines the horizontal direction.

The spline joint 60 is formed by an adapter 62, which forms a rigid spline connection to the first shaft 52, and an articulating spline connection to the second shaft 54. The rigid spline connection to the first shaft 52, means that the adapter 62 is fully constrained with respect to the first shaft 52, with no freedom of movement. Therefore, an axis 64 extending centrally through the adapter 62 will always be coincident with the axis 56 of the drive train 50 and first shaft 52.

The articulating spline connection formed with the second shaft 54, on the other hand, allows the second shaft 54 to move relative to the adapter 62 and the first shaft 52, whilst still transferring torque from the adapter 62 to the second shaft 54. Generally, the movement can be seen as a pivoting of the second shaft 54 relative to the drive train axis 56, so that the second shaft does not extend along the drive train axis 56. The pivot point for the second shaft 54 may be at the adapter 62 or the accessory unit 25.

In use, there may be some relative movement of the different regions of the gas turbine engine 10. The use of an articulating spline accommodates any relative movement of the core 11, and the region in which the accessory unit 25 is mounted, without damage being caused.

The adapter 62 will now be described in more detail, with reference to FIGS. 5A to 5C. The adapter 62 is formed of a cylindrical sidewall 66 formed around and along the joint axis 64. The sidewall 66 defines a passage 68 extending through the adapter 60.

At a first end 70, the passage 68 is open. A plurality of axially extending (with respect to the joint axis 64) ridges 74 are formed on an inner surface 76 of the sidewall 66. The plurality of ridges 74 extend around the circumference of the passage 68, and along a portion of the length of the passage 68, to form an engagement portion of the passage 80. The engagement portion 80 extends to a first axial length along the passage 68, towards the second end 72.

At the second end 72 of the passage 68, opposite the first end 70, the passage 68 is closed by a circular end wall 82, extending perpendicular to the joint axis 64. An opening 84 is formed in the centre of the end wall 82, such that the joint axis 64 extends through the opening 84. A cylindrical inner wall 86 extends from the edge of the opening 84, into the passage 68.

An annular trough 88 is formed between the inner wall 86 and the sidewall 66. The base of the trough 88 is formed by the end wall 82. The trough 88 has a radial width 90 between the sidewall 66 and the inner wall 86, and a depth defined by the axial length 92 that the inner wall extends into the passage 68, from the end wall 82.

The inner wall 86 has a first end 94 received in the passage 68, and a second end 96 at the end wall 88. The first end 94 of the inner wall 86 is at a second axial position along the passage 68. The second axial position is provided between the first axial position (the extent of the engagement portion 80) and the end wall 82, such that an axial spacing is provided between the engagement portion 80 and the trough 88.

An annular flange 98 is formed on the outer surface 78 of the sidewall 66, between the first end 70 and the second end 72. The flange 98 extends around the circumference the sidewall 66, and extends radially outward, with a first face 100 facing towards the first end 70 of the passage 68, and an opposing second axial face 102, facing the opposite direction. The first face 100 includes a step 106 in the axial direction.

An annular outer wall 104 extends axially from the second axial face 102 of the flange 98, towards the second end 72 of the passage 68. The outer wall 104 extends along a portion of the length of the sidewall 66 towards the second end 72, and is radially spaced from the sidewall 68, such that the outer wall 104 aligns with the step 106 in the first axial face 100 of the flange 98. An annular outer portion 108 of the second axial face 102 of the flange 98 is formed radially outward of the outer wall 104.

Axially extending (with respect to the joint axis 64) ridges 110 are formed on an outer surface 111 of the outer wall 104, extending around the circumference of the outer wall 104, and along the length of the outer wall 104, to form a second engagement portion 112.

The sidewall 66, inner 86, outer wall 104, flange 98, opening 84 and trough 88 are axisymmetric around the axis of the joint 64.

FIGS. 6A to 6C schematically illustrate the adapter 62 of FIGS. 5A to 5C coupled to a first shaft 52 and a second shaft 54, to form a spline joint 60, in various different usage scenarios. The first and second shafts 52, 54 are both cylindrical shafts having respective passages 114, 116 extending through them, which are open at both ends.

The first shaft 52, which is the radially inner shaft, with reference to FIG. 4, has a plurality of axially extending (with respect to the joint axis 64) ridges 118 on an inner surface 120 of the passage 114 adjacent the end 122 of the shaft 52 which engages the adapter 62. The ridges 118 extend around the circumference of the passage 114, and along a portion of the length of the passage 114, to form an engagement portion of the passage 120. The engagement portion 124 extends to a first axial length along the passage 114, away from the end 122.

In the assembled joint 60, the first shaft extends over the second end 72 of the adapter 62, around the outer wall 104. The ridges 110 of the second engagement portion 112 of the adapter 62 engage the ridges 118 of the engagement portion 124 of the first shaft 52, so that torque is transmitted from the first shaft 52 to the adapter 62.

The end 112 of the first shaft includes a annular flange 126 that has a face 128 facing towards and mating with the annular outer portion 108 of the adapter 62. A plurality of nuts and bolts (not shown) passing through the flange 126 in the shaft 52 and the annular outer portion 108 of the flange 98 of the adapter 62, to secure the first shaft 52 to the adapter 62. As such, the joint of the first shaft 52 to the adapter 62 is a rigid joint.

The second shaft 54 extends into the open end 70 of the passage 68. Axially extending (with respect to the joint axis 64) ridges 130 are formed on an outer surface 132 of the outer wall second shaft 54, at an end 136 received in the passage 68. The ridges 130 extend around the circumference of the shaft 54, along at least a portion of the length of the shaft 54, to form an engagement portion 134 on the second shaft

The ridges 74 of the first engagement portion 80 of the adapter 62 engage the ridges 130 of the engagement portion 134 of the second shaft 54, so that torque is transmitted from the adapter 62 to the second shaft 54. The second shaft 54 is not secured to the adapter 54. Furthermore, there is some radial clearance between the outer surface 132 of the second shaft 54, and the inner surface 76 of the passage. Whilst the ridges 74, 130 may still engage to transfer torque, this clearance is sufficient to allow some relative movement of the adapter 62 and second shaft 54. Therefore, the joint between the second shaft 54 and the adapter 62 is an articulating spline.

The second shaft 54 only extends partway into the passage 68. The second shaft 54 extends a sufficient length into the passage that the engagement portions 80, 134 can transfer torque over the range of movement of the articulating spline, but an axial spacing is still provided between the end 136 of the second shaft 54 and the first end 94 of the inner wall 86. Radial projections (not shown) may extend into the passage, and/or be formed in the outer surface of the second shaft 132 to limit the extent the second shaft 54 extends into the passage 68, or the axial position of the second shaft may be limited in other suitable ways.

FIG. 6A illustrates the spline joint 60 during and after engine shutdown. Oil, or other lubricant 138, that is used to lubricate the engagement portions 80, 134 during engine operation, is collected in the trough 88 formed at the closed end 72 of the passage 68.

FIG. 6B illustrates the spline joint 60 during engine start-up, when the accessory drive train 50 starts to rotate. Centrifugal force acting on the lubricant 138 causes the lubricant to migrate to the sidewall 66, and up the sidewall 66 to the engagement portions 80, 134. This provides lubricant 138 to the joint 60. The arrows in FIG. 6B illustrate the direction in which the lubricant 138 migrates.

FIG. 6C illustrates the spline joint 60 during normal operation of the engine 10. Lubricant 138 is provided to the joint through the passage 116 formed in the second shaft 54. The lubricant 138 is provided by the lubrication system 42. In use, the lubricant 138 may escape out of the open end 70 of the adapter 62. Escaped lubricant 138 may be collected and recycled as part of the turbine engine lubrication system 42.

After the engine has shut down, lubricant remaining at the engagement portions 80, 134 is collected in the trough for use on the next start-up.

The lubrication system 42, which provides lubricant 138 during normal engine operation, is driven by the accessory unit 25, which in turn is driven by the core shaft 27. This means that at engine start-up, before there is sufficient rotation to drive the lubrication system 42, the lubrication system 42 is not primed and cannot provide lubricant to the joint 60. However, as discussed above, the centrifugal force acting on the lubricant 138 in the trough ensures lubricant is provided form engine turn-on.

The axial height 92 of the inner wall 86 and the radial width 90 of the trough 88 are selected, taking into account the angle 58 of the drive train axis 56, such that the trough 88 can collect sufficient lubricant 138 to lubricate the engagement portions 80, 134 until the lubrication system 42 can provide lubricant. Therefore, the trough 88 holds the same amount of lubricant 138 as would be held in the articulated spline at any given point during normal use.

The axial height 92 of the inner wall 86 is limited to ensure that excess lubricant 138 is not collected. Instead, excess lubricant flows through the passage formed by the inner wall 86 and the opening 84 in the end wall 82. Where the drive train axis 56 (and joint axis 64) are not completely radial, the lubricant 138 in the trough 88 is not axisymmetric, with respect to the joint axis 64. This can lead to unbalanced loads, which are undesirable. Limiting the volume of lubricant 138 limits the amount of unbalanced loads. Ensuring that the joint 60 is axisymmetric also helps this.

In use, a pressure different may build up between the core engine 11, and the region in which the accessory unit 25 is mounted. The inner wall 86 and opening 84 form a chimney 140 that allows air or fluid to pass through the opening 84, from the first shaft 52 to the second shaft 54, such that the pressure different does not force axial movement of the second shaft 54 relative to the first shaft 52.

In the example discussed above, the drive train axis 56 is inclined relative to the principal axis 9 of the engine 10. It will be appreciated that the spline joint 60 incorporating a chimney 140 arranged to form a trough 88 may be used in any drivetrain with appropriate incline. For example, the absolute value of the first angle 58 between principal axis 9 and drive train axis 56 may be between 45 degrees and 90 degrees. This ensures that sufficient lubricant 138 is retained in the trough 88, and the load of the lubricant 138 is sufficiently axisymmetric around the drive train axis 56. The drive train may also include a step aside gearbox, or the like, within the drive train, to enable variations or sideways steps in the drive train axis 56.

In the examples discussed above, the rigid joint between the adapter 62 and the first shaft 52 is formed on an outer wall 104, spaced from the sidewall 66. In other examples, the engagement portion 112 may be formed on the outer surface 78 of the sidewall 66. In further examples, the rigid joint may be formed by receiving the first shaft 52 within the passage 68.

Furthermore, in the above examples, the wall 82 forming the base of the trough 88 is provided at the end 72 of the passage 68. However, it will be appreciated that the base of the trough 88 may be formed by a wall extending across the passage 68 at any position along the passage. Furthermore, in some examples, the base of the trough 88 may not extend perpendicular to the wall 68. Instead, the base may be at an inclined or shaped. For example, the end wall 82 may be perpendicular to the axis of the second shaft 54, or may be inclined towards the inner wall 86, to enable collection of lubricant and/or to promote feeding of lubricant 138 to the joint at engine start up.

In the above examples, the joint 60 between the shafts 52, 54 is formed by an adapter 62. It will be appreciated that this is by way of example only. In alternative examples, the shafts 52, 54 may connect directly to each other.

In one example embodiment, shown in FIG. 7A, the second shaft 54 may be received within the open end 122 of the first shaft 52. The end 122 of the first shaft 52 may be provided with an engagement portion 142 in a similar manner to the first end 70 of the adapter 62, so that the joint is an articulating joint. A wall 144 is provided extending perpendicular across the passage 114 formed by the first shaft 52, spaced form the end 122, so that a trough 146 is formed in the end of the first shaft 52. A chimney 148 is formed in the trough 146, in a similar manner to the adapter 62 discussed above. The trough 146 collects lubricant 138 in a similar manner to that discussed in relation to FIG. 6A, and lubricates the articulating spline in a similar manner to the trough 88 formed in the adapter 62, as discussed in relation to FIG. 6B. In use, lubricant is provided by a separate system 42 driven by the accessory unit 25, as shown in FIG. 6C.

In another example embodiment, shown in FIG. 7B, the first shaft 52 is received in the end 136 of the second shaft. In this embodiment, the first shaft engagement portion 150 is formed on the outside of the first shaft 52, near the end 122 of the first shaft 52, and the second shaft engagement portion 152 is formed on the inner of the second shaft 54, near the end 136 of the second shaft 54. In this way, the first shaft 52 is connected by an articulating joint, rather than the second shaft 54.

In this example embodiment, a trough 154, with a chimney 156, is formed in the end 122 of the first shaft 52, in a similar manner to that shown in FIG. 7A. Furthermore, a weir or step 158 is formed in the inner surface of the second shaft 54, axially above the engagement portion 152.

In this embodiment, lubricant 138 is collected in the trough 154, in a similar manner to that discussed in relation to FIG. 6A. On engine start up, the lubricant 138 is drawn up the side of the trough 154, in a similar manner to that discussed in relation to FIG. 6B. The lubricant is further drawn up the side of the second shaft 54, until it reaches the weir 158, which prevents the lubricant being drawn any further. Instead, lubricant builds up behind the weir 158, to lubricate the engagement portions 150, 152. The radial width of the weir 158 control the amount of lubricant retained. Once the layer of lubricant is thicker than the weir, 158, lubricant continues to be drawn up the second shaft 54. As such, the weir 158 should be sized to retain lubricant in the joint. In normal use, lubricant is provided by a separate system 42 driven by the accessory unit 25, as shown in FIG. 6C.

It will also be appreciated that the joints shown in FIGS. 7A and 7B may be formed by an adapter. In this example, the trough 146, 154 is again formed in the end 122 of the first shaft 52, and the adapter is either received in the end of the first shaft 52 (in a similar manner to that shown in FIG. 7A), or receives the first shaft 52 (in a similar manner to that shown in FIG. 7B).

In one example of a joint formed by an adapter with an articulating joint to the first (lower) shaft 52, the second shaft 54 is connected to the adapter by a rigid joint. The second shaft 52 may be received in an end of the adapter to form a rigid joint, or may receive an end of the adapter, to form a rigid joint. The rigid joint may include a further connection between the adapter and second shaft 54, for example through nuts and bolts. In yet further examples, both shafts 52, 54 may be connected to the adapter by articulating joints. In one example, both joints are lubricated at engine start up by troughs 88, 146, 154—a first 88 formed in the adapter, and a second 146, 154 formed in the end 122 of the first shaft 52. In other examples, one of the joints may be lubricated by a trough, and the other by other suitable lubrication means.

In the examples discussed above, the chimney 140, 148, 156 is formed by a single opening 84 in a wall 82, 144 forming a base of the trough 88, 146, 154, surrounded by an inner wall 86 at the edge of the opening 84. In other examples, the inner wall 86 may have a larger diameter than the opening 84, so that the inner wall 86 is spaced from the edge of the opening 84. In other examples, the inner wall 86 may surround a plurality of openings, rather than a single one.

In the examples discussed above, the spline joint 60 has been discussed in relation to an inclined drive train 50 for an accessory unit 25, mounted away from the engine core 11. However, it will be appreciated that the spline joint 60 may be used at any situation having a vertical or inclined drive shaft. The joint 60 may be used at any position within a gas turbine engine 10, or any other situation where lubrication of articulated spline joints is required. In addition, the joint does not necessarily have to be used when connecting two shafts. The joint may be used where a shaft connects into a gearbox, or the accessory unit 25, as required.

In the examples discussed above, the shafts 52, 54 and adapter are cylindrical. However, it will be appreciated that any suitable shape shaft may be used. Furthermore, the trough 88, 146, 154 may be used to collect lubricant, and lubricate an articulating joint during engine transients, when power to the lubrication system 42 is interrupted, as well as at shut down and start up.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A spline joint comprising:
a sidewall extending along and around an axis defining an axial direction of the joint,
wherein the sidewall defines a passage extending from a first end to a second end;
wherein the passage is arranged to receive an end of a shaft at the first end; and
wherein an engagement portion of an inner surface of the sidewall adjacent the first end is arranged to engage a shaft received in the passage, to transmit torque to the shaft;
a base wall extending across the passage and axially spaced from the first end of the passage;
an opening formed through the base wall; and
an inner wall extending around the opening and in the axial direction from the base wall, such that an annular trough arranged to retain lubricant for the spline joint is defined between the sidewall and the inner wall.

2. The spline joint of claim 1, wherein the spline joint is axisymmetric.

3. The spline joint of claim 1, wherein the inner wall extends from a first end, to a second end; and wherein the first end of the inner wall is between the first end of the passage and the base wall, and the second end of the inner wall is at the base wall.

4. The spline joint of claim 3, wherein the engagement portion extends a portion of the axial length of the sidewall from the first end; and wherein the first end of the inner wall is axially spaced from the engagement portion.

5. The spline joint of claim 1, wherein the trough is arranged to provide lubricant to the engagement portion through centrifugal force.

6. The spline joint of claim 5, wherein the axial direction is at least 45 degrees to horizontal.

7. The spline joint of claim 6, wherein the axial direction is perpendicular to horizontal.

8. The spline joint of claim 1, wherein the spline joint is an articulating spline.

9. The spline joint of claim 1, including:
a second engagement portion arranged to engage another shaft extending in the axial direction,
wherein the second engagement portion is radially outside the engagement portion on the inner surface the passage, and wherein the second engagement portion is arranged to be received within the other shaft, such that the spline joint comprises an adapter arranged to join a first shaft received in the passage and a second shaft receiving the spline joint.

10. The spline joint of claim 9, wherein the second engagement portion is arranged to form a rigid joint to the second shaft.

11. The spline joint of claim 1, wherein the spline joint is formed in an end of a shaft, such that the spline joint joins a shaft incorporating the passage and a shaft received in the passage.

12. A gas turbine engine for an aircraft comprising:
an engine core including a turbine, a compressor, and a core shaft driven by the turbine;
an accessory unit for driving hydraulic, pneumatic and electrical systems of the turbine engine;
a fan located upstream of the engine core, the fan comprising a plurality of fan blades and being driven by the engine core; and
an accessory drive train for providing a portion of the power of the core shaft to the accessory unit,
wherein the accessory drive train extends radially from the core shaft; and wherein the accessory drive train includes a spline joint, wherein the spline joint comprising:
a sidewall extending along and around an axis defining an axial direction of the joint,
wherein the sidewall defines a passage extending from a first end to a second end;
wherein the passage is arranged to receive an end of a shaft at the first end; and
wherein an engagement portion of an inner surface of the sidewall adjacent the first end is arranged to engage a shaft received in the passage, to transmit torque to the shaft;
a base wall extending across the passage and axially spaced from the first end of the passage;
an opening formed through the base wall; and
an inner wall extending around the opening and in the axial direction from the base wall, such that an annular trough arranged to retain lubricant for the spline joint is defined between the sidewall and the inner wall.

13. The gas turbine engine of claim 12, including:
a lubrication system arranged to deliver lubricant to the spline joint, during engine operation,
wherein the lubrication system is driven by the accessory unit; and
wherein the trough of the spline joint delivers lubricant, when the lubrication system is not primed.

14. The gas turbine engine of claim 13, wherein a radial width of the trough between the sidewall and inner wall, and an axial length of the inner wall is arranged such that the volume of lubricant in the trough on engine shutdown is equal or substantially equal to the volume of lubricant held in the joint during use; and wherein excess lubricant flows through the opening.

15. The gas turbine engine of claim 12, wherein the core shaft has a principal axis, the accessory drive train includes a first shaft, operatively coupled to the spline joint, and wherein the first shaft extends at an angle of 45 degrees or more from the principal axis defined by the core shaft.

16. The gas turbine engine of claim 12, including
a power gearbox that receives an input from the core and outputs drive to the fan, wherein the power gearbox is a step down gearbox.

17. The gas turbine engine of claim 12, wherein:
the turbine is a first turbine, the compressor is a first compressor, and the core shaft is a first core shaft;
the engine core further comprises a second turbine, a second compressor, and a second core shaft connecting the second turbine to the second compressor.

18. The gas turbine engine of claim 17, wherein
the second core shaft is arranged to rotate at a lower rotational speed than the first core shaft; and
the input to the power gearbox is provided by the second core shaft.
